(19) United States
(12) Patent Application Publication
(10) Pub. No.: US 2020/0159010 A1
(43) Pub. Date: May 21, 2020

(54) SELF-CLEANING SENSOR HOUSINGS

(71) Applicant: Aptiv Technologies Limited, St. Michael (BB)

(72) Inventors: Lucas Tetsuya Kuwae, Singapore (SG); Zhi Min Ng, Singapore (SG); Hwee Peng Tan, Singapore (SG); Alejandro Israel Barragan Diaz, Singapore (SG)

(21) Appl. No.: 16/682,150

(22) Filed: Nov. 13, 2019

Related U.S. Application Data
(60) Provisional application No. 62/769,721, filed on Nov. 20, 2018.

(51) Int. Cl. G02B 27/00; B08B 5/02; B08B 1/00; G01D 11/24

(52) U.S. Cl. CPC G02B 27/0006; G01D 11/245; B08B 1/006; B08B 5/02

(57) ABSTRACT

Among other things, we describe a self-cleaning sensor housing. The self-cleaning sensor housing includes at least one sensor comprising a sensor aperture, a motor rotatable about a first axis of revolution, a substantially transparent screen rotatable about a second fixed axis of revolution, and a cleaning mechanism located proximate to the screen and configured to contact the substantially transparent screen. The screen is mechanically coupled to the motor and covers at least a portion of the sensor aperture. We also describe methods for performing self-cleaning operations.

### CROSS-REFERENCE TO RELATED APPLICATION

This application claims the benefit of U.S. Provisional Application 62/769,721, filed on Nov. 20, 2018, which is incorporated herein by reference in its entirety.

### FIELD OF THE INVENTION

This disclosure generally relates to sensor housings. In particular, this description relates to self-cleaning sensor housings.

### BACKGROUND

Increasingly, vehicles, such as cars, buses, trucks, and drones, are equipped with several sensors to detect the environment in which the vehicles operate. Moreover, autonomous vehicles, such as self-driving cars and self-operated drones, may generally require sensors to help them navigate through the environment in which they operate. Vehicles may use several types of sensors to detect the surrounding environment, such as light detection and ranging (LiDAR) sensors, RADAR sensors, and cameras. During operation, these sensors may be exposed to the environment, which can cause dirt, oil, and/or water to accumulate on various sensor components, including apertures and protective screens. This may lead to a decrease in sensor performance, as occlusions in the aperture's line of sight can lower a sensor's accuracy. Therefore, these sensors may need to be cleaned regularly to preserve their ability to detect the surrounding environment.

### SUMMARY

Techniques are provided for systems comprising a sensor housing. The sensor housing includes a first sensor, a motor rotatable about a first fixed axis of revolution, and a substantially transparent screen rotatable about a second fixed axis of revolution. The substantially transparent screen is mechanically coupled to the motor and covers at least a portion of the sensor aperture when the motor is in a first position. The sensor housing includes a cleaning mechanism located proximate to the screen when the motor is in at least a second position. The cleaning mechanism is configured to contact the substantially transparent screen.

At least a portion of the cleaning mechanism may include a microfiber material. At least a portion of the cleaning mechanism may include a cellulose sponge. The cleaning mechanism may include an outlet configured to release pressurized air.

The motor may be mechanically coupled to the screen using a line and one or more pulleys. At least a portion of the screen may include an acrylic-based material. At least a portion of the screen may include polyethylene terephthalate. At least a portion of the screen may include thermoplastic polyurethane. The first axis of revolution and the second axis of revolution may be oriented in substantially similar directions.

The motor may be configured to be actuated when the first sensor's accuracy is below a threshold value. The motor may be configured to be actuated when the first sensor detects an occlusion. The motor may be configured to output a torque having a value of at least 1 Nm. The motor may be configured to rotate at a rotational speed of at least 1 rotation-per-minute. The sensor housing may also include a second sensor configured to perform sensing operations when the motor is actuated.

Another aspect of the present disclosure is directed to a method. The method includes rotating, by a motor rotatable about a first axis of revolution, a substantially transparent screen covering at least a portion of an aperture of a first sensor when the motor is in a first position, wherein the screen is rotated about a second fixed axis of revolution. The method includes contacting, by a cleaning mechanism located proximate to the screen when the motor is in at least a second position, the screen to remove one or more substances from the screen.

The motor may be actuated when the sensor's accuracy is below a threshold accuracy value. The motor may be actuated when the first sensor detects an occlusion. Rotating the screen may include using a line and one or more pulleys to rotate the screen. Rotating the screen may include rotating the motor at a rotational speed of at least 1 rotation-per-minute. The method may further include performing, by a second sensor, sensing operations during the rotating of the screen.

The cleaning mechanism may include a microfiber material and contacting the screen may include contacting the screen with the microfiber material. The cleaning mechanism may include an outlet configured to release pressurized air and contacting the screen may include contacting the screen with the pressurized air.

These and other aspects, features, and implementations can be expressed as methods, apparatus, systems, components, program products, means or steps for performing a function, and in other ways.

In another aspect, a sensor of a vehicle is used to receive multiple images representing an environment in which the vehicle is operating. The sensor is located within a sensor housing of the vehicle. The sensor includes a sensor aperture. One or more processors of the vehicle are used to detect that the sensor aperture is occluded based on the multiple images. The detecting includes using the one or more processors to identify first one or more pixels located at a first location in a first image of the multiple images. The first one or more pixels have a first brightness that does not meet a brightness threshold. The one or more processors are used to identify second one or more pixels located at the first location in a second image of the multiple images. The second one or more pixels have a second brightness that does not meet the brightness threshold. Responsive to the detecting that the sensor aperture is occluded, an actuator of the sensor housing operates a cleaning mechanism to contact a screen of the sensor housing. The screen covers the sensor aperture.

In another aspect, a sensor housing of a vehicle includes a sensor casing. The sensor casing includes a sensor of the vehicle and a screen covering at least a portion of the sensor. An air chamber is mounted on the sensor casing and shaped to contain pressurized air. The air chamber includes an inlet shaped to allow the pressurized air to enter the air chamber. An outlet slot is shaped to emit the compressed air in a manner to prevent occlusion of the sensor.

In another aspect, a light detection and ranging (LiDAR) housing includes a LiDAR casing having a cylindrical shape. The LiDAR casing includes multiple LiDAR sensors disposed in a spaced configuration along a peripheral surface of the LiDAR casing. An air chamber is mounted on a base of the LiDAR casing and shaped to contain pressurized air. The air chamber includes multiple outlet slots disposed along a periphery of the air chamber. Each outlet slot of the multiple outlet slots is shaped to emit a respective portion of the pressurized air in a manner to prevent occlusion of one or more LiDAR sensors of the multiple LiDAR sensors.

These and other aspects, features, and implementations will become apparent from the following descriptions, including the claims.

### BRIEF DESCRIPTION OF THE DRAWINGS

FIG. 1 illustrates an example of an autonomous vehicle having autonomous capability.

FIG. 2 illustrates an example “cloud” computing environment.

FIG. 3 illustrates a computer system.

FIG. 4 illustrates an example architecture for an autonomous vehicle.

FIG. 5 illustrates an example of inputs and outputs that may be used by a perception module.

FIG. 6 illustrates an example of a LiDAR system.

FIG. 7 illustrates the LiDAR system in operation.

FIG. 8 illustrates the operation of the LiDAR system in additional detail.

FIG. 9 illustrates a block diagram of the relationships between inputs and outputs of a planning module.

FIG. 10 illustrates a directed graph used in path planning.

FIG. 11 illustrates a block diagram of the inputs and outputs of a control module.

FIG. 12 illustrates a block diagram of the inputs, outputs, and components of a controller.

FIG. 13 illustrates an example of a sensor housing having self-cleaning capability.

FIG. 14 illustrates an example of a sensor housing, which includes two sensors, having self-cleaning capability.

FIG. 15 is a flow diagram illustrating a method for performing self-cleaning operations.

FIG. 16 is a flow diagram illustrating a method for determining whether debris is blocking a sensor aperture.

FIG. 17 illustrates a sensor housing of a vehicle.

FIG. 18 illustrates a section of a sensor housing of a vehicle.

FIG. 19. illustrates a light detection and ranging (LiDAR) sensor housing.

FIG. 20 illustrates a section of a LiDAR sensor housing.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. Autonomous Vehicle Architecture

4. Autonomous Vehicle Inputs

5. Autonomous Vehicle Planning

6. Autonomous Vehicle Control

7. Self-Cleaning Sensor Housing

### General Overview

Recently, equipping vehicles, such as cars and drones, with sensors to detect the environment in which the vehicles operate is becoming more and more popular. Moreover, autonomous vehicles, such as self-driving cars and self-operated drones, may generally require sensors to help them navigate through the environment in which they operate. Vehicles may use several types of sensors to detect the surrounding environment, such as light detection and ranging (LiDAR) sensors, RADAR sensors, and cameras. During operation, these sensors may be exposed to the environment, which can cause dirt, oil, and/or water to accumulate on various sensor components, including apertures and protective screens. This may lead to a decrease in sensor performance, as occlusions in the aperture's line of sight can lower a sensor's accuracy. Therefore, these sensors may need to be cleaned regularly to preserve their ability to detect the surrounding environment.

Sensor components, such as apertures or protective screens, typically require manual cleaning when they become dirty or wet. When being used on a vehicle, this may require discontinuing the operation of the vehicle so that a user (or technician) can clean the various sensor components. However, discontinuing operations to clean a sensor may not be feasible while the vehicle is traversing a route. This process can also be laborious and cost ineffective. Thus, a sensor having self-cleaning capabilities may be desired for use with an autonomous vehicle.

This disclosure provides a self-cleaning sensor housing. The sensor housing includes a first sensor having an aperture. A substantially transparent screen covers the aperture at least partially and is configured to be rotated by a motor. As the screen rotates, it is contacted by a cleaning mechanism located proximate to the screen. The sensor housing can be utilized by various types of vehicles that are typically equipped with sensors to improve the efficiency of the sensors.

### System Overview

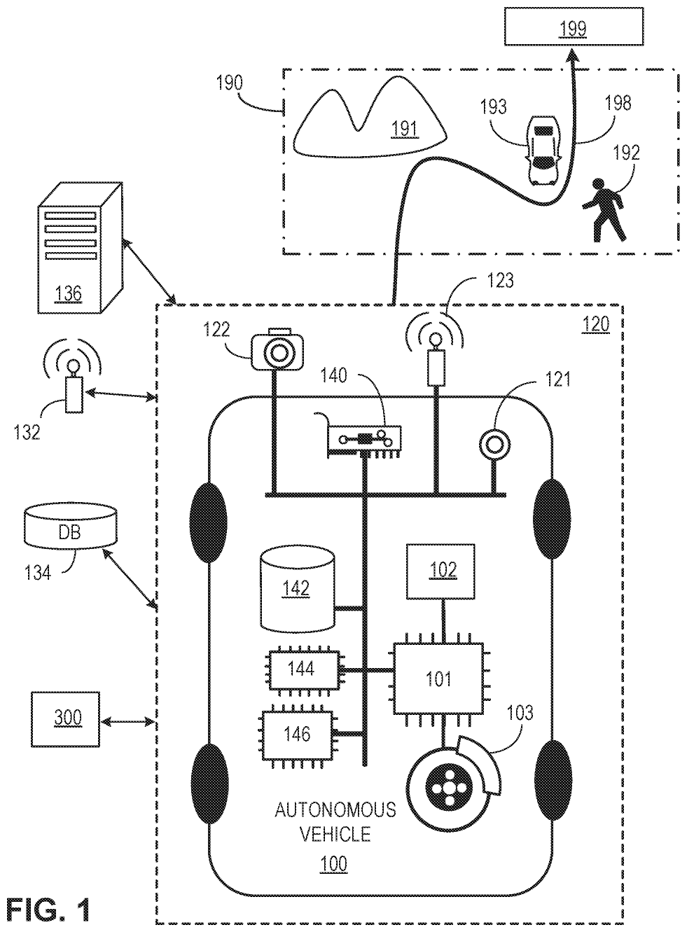

FIG. 1 illustrates an example of an autonomous vehicle 100 having autonomous capability.

As used herein, the term “autonomous capability” refers to a function, feature, or facility that enables a vehicle to be partially or fully operated without real-time human intervention, including, without limitation, fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle, and may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

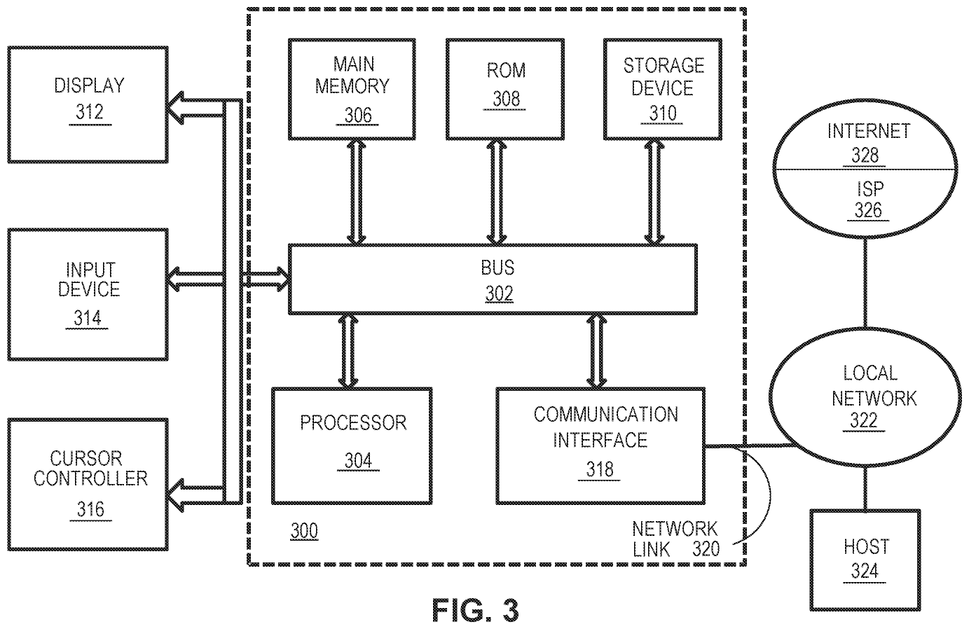

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any level, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear and angular velocity and acceleration, and heading (e.g., an orientation of the leading end of AV 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates, or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

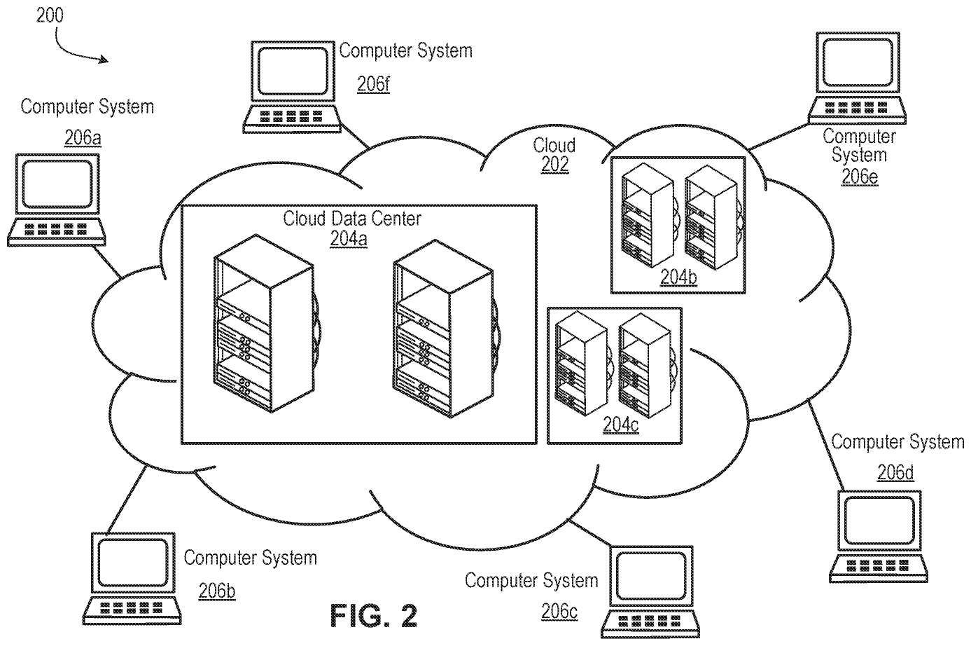

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

FIG. 2 illustrates an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.), and consumer electronics. In an embodiment, the computing systems 206a-f are implemented in or as a part of other systems.

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices, or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to an embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire, and fiber optics, including the wires that comprise the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

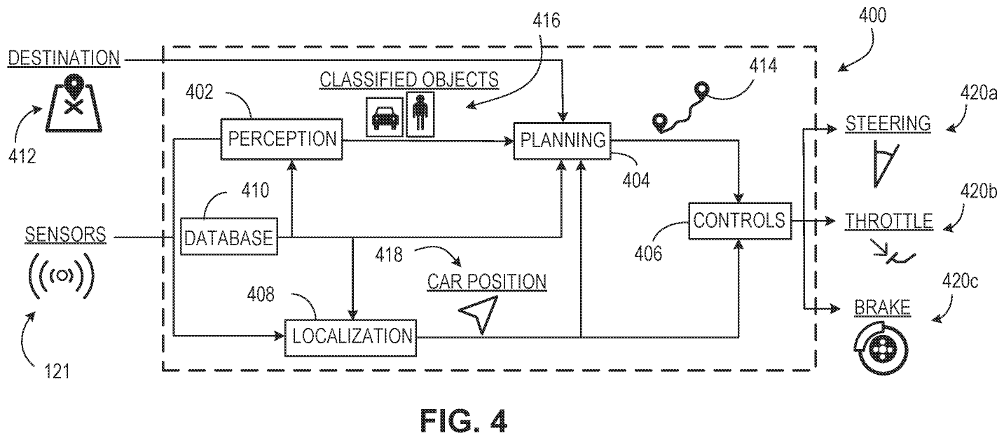

FIG. 4 illustrates an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Navigation Satellite System) sensor and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs, or other travel signals of various types.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Autonomous Vehicle Inputs

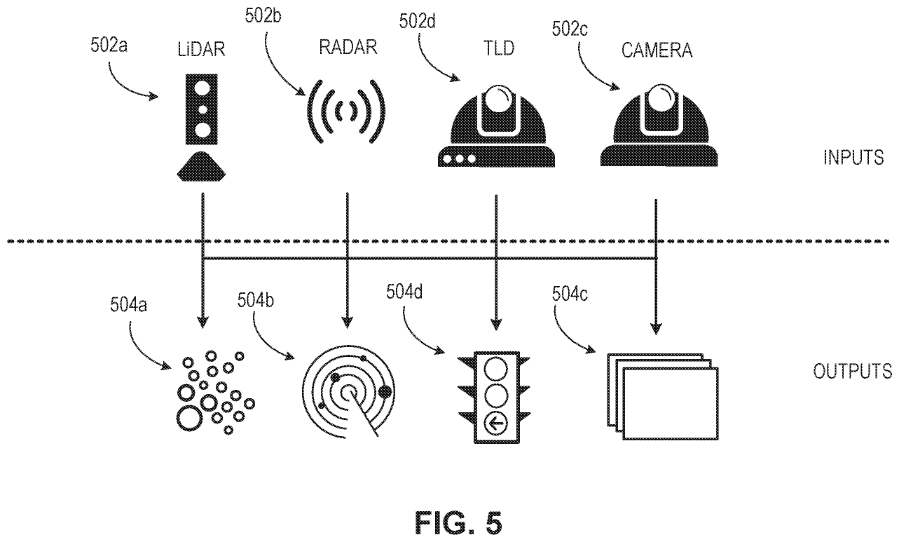

FIG. 5 illustrates an example of inputs 502a-d (e.g., sensors 121 shown in FIG. 1) and outputs 504a-d (e.g., sensor data) that is used by the perception module 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the AV 100 has access to all relevant navigation information provided by these objects. For example, the viewing angle of the TLD system may be about 120 degrees or more.

In some embodiments, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

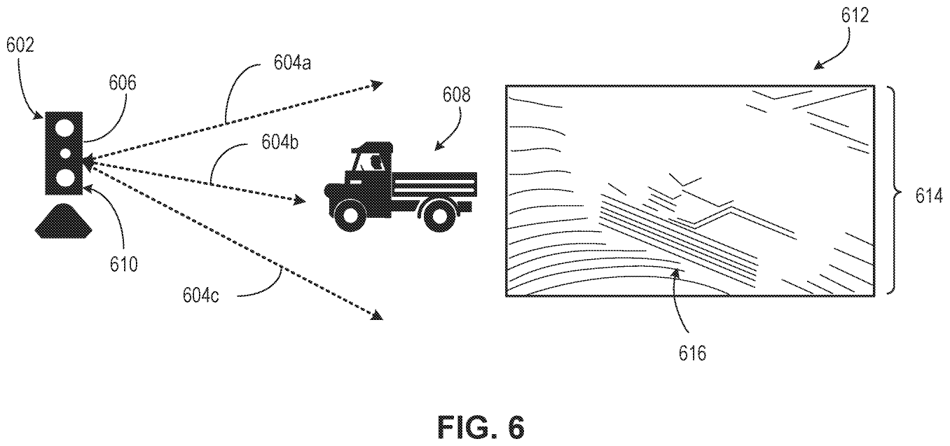

FIG. 6 illustrates an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum, for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

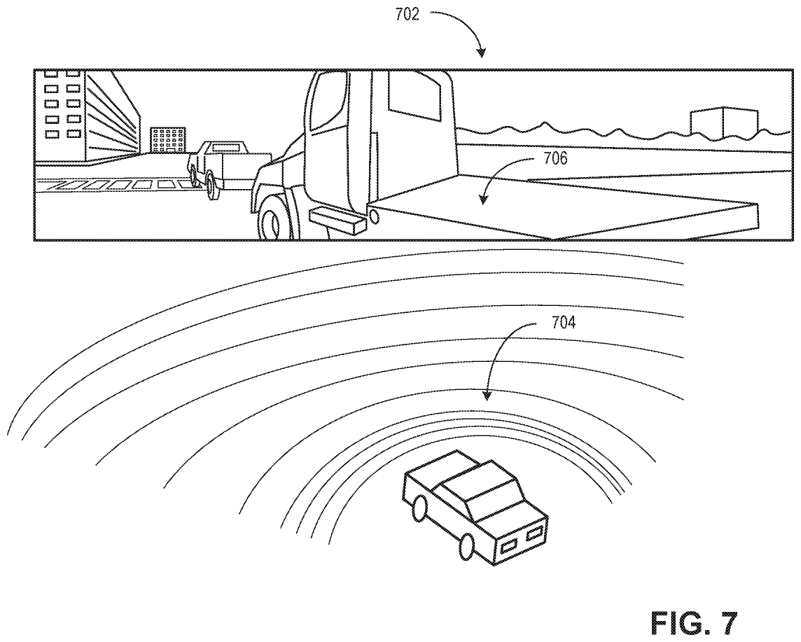

FIG. 7 illustrates the LiDAR system 602 in operation. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

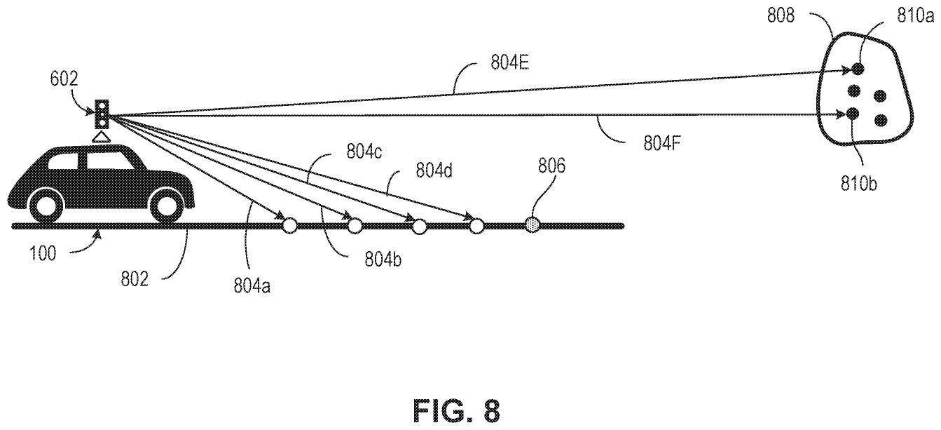

FIG. 8 illustrates the operation of the LiDAR system 602 in additional detail. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

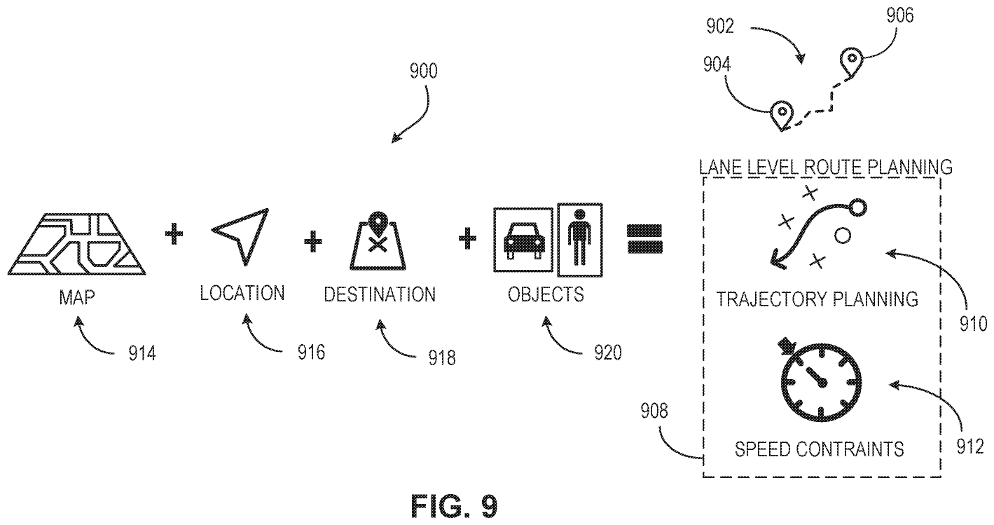

FIG. 9 illustrates a block diagram 900 of the relationships between inputs and outputs of a planning module 404 (e.g., as shown in FIG. 4). In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In some embodiments, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

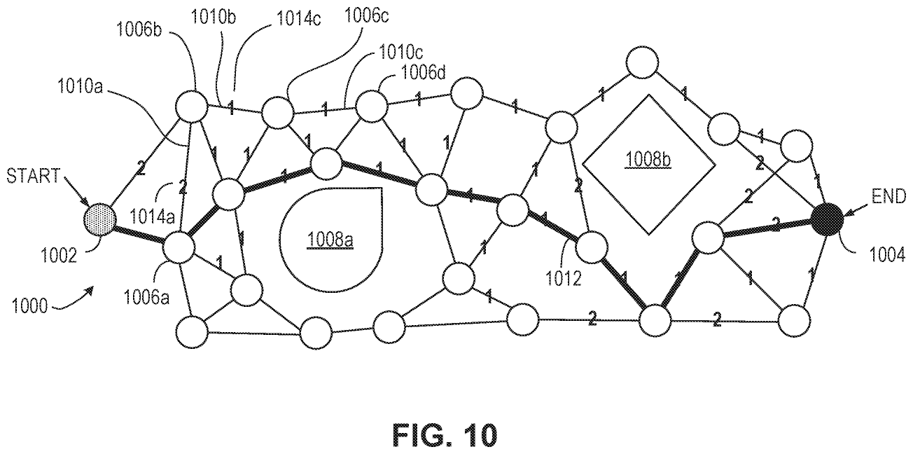

FIG. 10 illustrates a directed graph 1000 used in path planning, e.g., by the planning module 404 (FIG. 4). In general, a directed graph 1000 like the one shown in FIG. 10 is used to determine a path between any start points 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, some or all of the objects 1008a-b are a static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 travels between the two physical positions represented by the respective nodes.) The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### Autonomous Vehicle Control

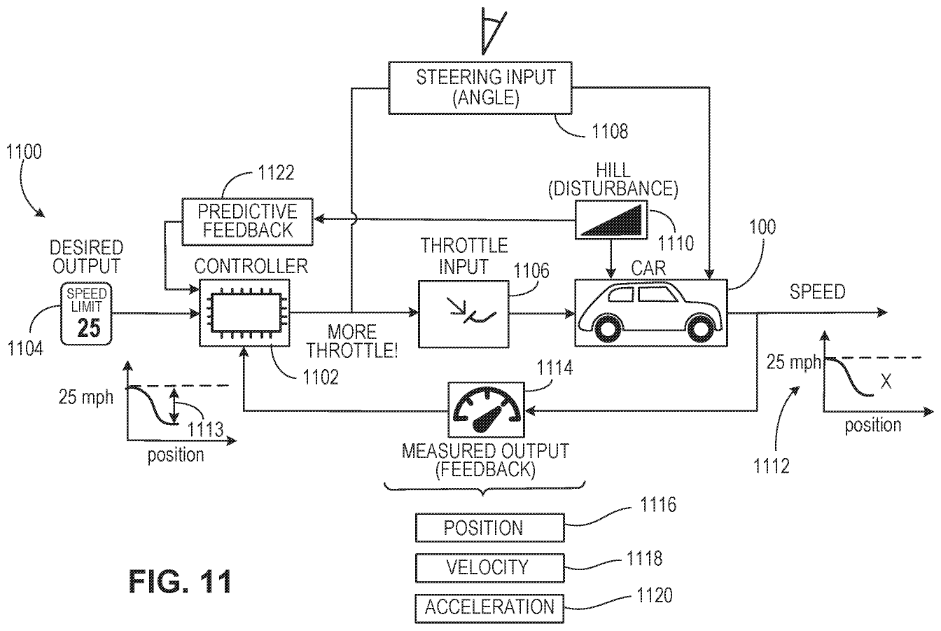

FIG. 11 illustrates a block diagram 1100 of the inputs and outputs of a control module 406 (e.g., as shown in FIG. 4). A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 1308, and storage device 210, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

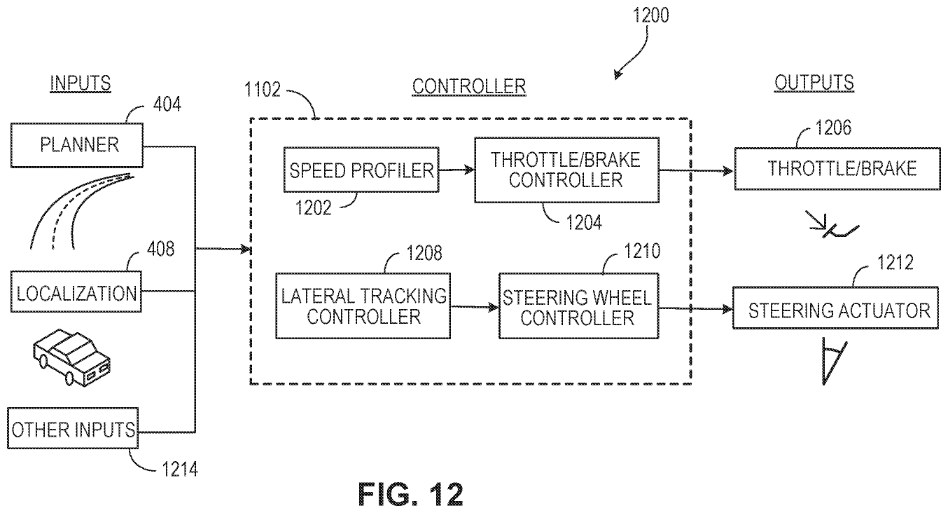

FIG. 12 illustrates a block diagram 1200 of the inputs, outputs, and components of the controller 1102. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1204 to adjust the position of the steering angle actuator 1212 depending on, for example, feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Self-Cleaning Sensor Housings

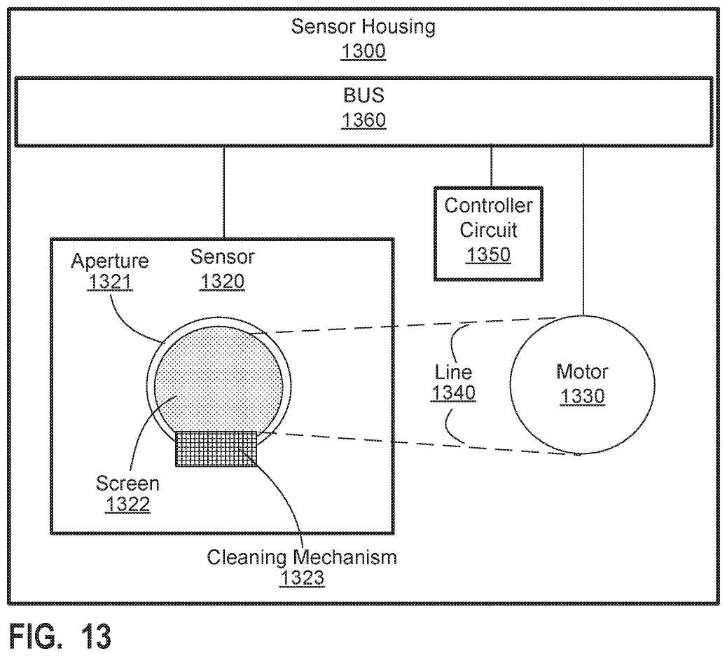

FIG. 13 illustrates an example of a sensor housing 1300 having self-cleaning capability, in accordance with one or more embodiments. In an embodiment, the sensor housing 1300 is mounted on an AV, such as the AV 100 previously described with reference to FIG. 1. However, the sensor housing 1300 can be provided on various other types of vehicles, such as conventional vehicles that may use sensors to detect their surrounding environment, manually operated drones, autonomous drones, etc. The sensor housing 1300 can also be located remotely. The sensor housing 1300 includes a sensor 1320, a motor 1330, and a housing controller circuit 1350. The sensor 1320, motor 1330 and housing controller circuit 1350 are communicatively coupled with one another via a bus 1360. The sensor 1320 includes an aperture 1321, a screen 1322, and a cleaning mechanism 1323. In an embodiment, the screen 1322 is configured to cover a portion of the aperture 1321 when the motor 1330 is in a first operational condition. As used herein, operational conditions describe the mode of operation that the motor 1330 may be in, such as, for example, in a static mode or in a rotational mode. Thus, a first mode of operation may refer to the motor 1330 as being in a static mode, while a second mode of operation may refer to the motor 1330 as being in a rotational mode. In an embodiment, the screen is configured to cover substantially all of the aperture 1321. The screen 1322 is mechanically coupled to the motor 1330 by a line 1340. The line 1340 is a drive element that translates rotational force from the motor 1330 to the screen 1322.

The sensor 1320 can be one of several types of sensing devices. For example, in an embodiment, the sensor 1320 is one of the sensors 121 discussed previously with reference to FIG. 1. In an embodiment, the sensor 1320 is one or more of the inputs 502a-c as discussed previously with reference to FIG. 5. In an embodiment, the sensor 1320 is a LiDAR. In an embodiment, the sensor 1320 is a RADAR. In an embodiment, the sensor 1320 is a camera. The camera can be a monocular or stereo video camera configured to capture light in the visible, infrared, and/or thermal spectra. In an embodiment, the sensor 1320 is an ultrasonic sensor. The sensor 1320 may also include a combination of sensing devices. For example, in an embodiment, the sensor 1320 includes a camera and a RADAR. The aperture 1321 may be a lens, a microelectromechanical system (MEMS), or other openings based on the type of sensing device used. For example, in an embodiment, the sensor 1320 is a camera and the aperture 1321 is a lens. In an embodiment, the sensor 1320 is a LiDAR and the aperture 1321 is a MEMS. In an embodiment, the sensor 1320 is a RADAR and the aperture 1321 is a lens. In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

The screen 1322 is made of a transparent protective material. For example, in an embodiment, the screen 1322 is made out of an acrylic-based material. In an embodiment, the screen 1322 is made out of polyethylene terephthalate (PET). In an embodiment, the screen 1322 is made out of thermoplastic polyurethane (TPU). In an embodiment, the screen 1322 is made out of tempered or toughened glass. The screen 1322 can be made of one of several glass or plastic materials or other transparent materials known to provide protective, scratch resistant benefits.

The cleaning mechanism 1323 is located proximate the screen 1322 when the motor is in at least a second operational condition (e.g., rotational mode). The cleaning mechanism 1323 is configured to contact the screen 1322. The cleaning mechanism 1323 may contact the screen directly or indirectly. For example, in an embodiment, the cleaning mechanism 1323 is in direct contact with the screen 1322. In an embodiment, the cleaning mechanism 1323 is at a close distance to the screen 1322, but is not contacting the screen 1322 directly. It may be more efficient for the cleaning mechanism 1323 to not contact the screen 1322 directly when the cleaning mechanism 1323 includes an outlet for releasing pressurized air (as discussed later), as the separation distance may allow the pressurized air to cover a larger surface area of the screen 1322. In an embodiment, the cleaning mechanism 1323 includes an actuator member configured to move the cleaning mechanism 1323 towards and away from the screen 1322, such that the cleaning mechanism 1323 can move to a first predefined position that allows the cleaning mechanism 1323 to directly contact the screen 1322 and move to a second predefined position where the cleaning mechanism 1323 is not in direct contact with the screen 1322. In an embodiment, the actuator member is integrated with the sensor 1320 and is controlled by the housing controller circuit 1350.

The cleaning mechanism 1323 can be made of one or more of several types of materials. For example, in an embodiment, the cleaning mechanism 1323 is made out of a microfiber material (e.g., a microfiber cloth). In an embodiment, the cleaning mechanism 1323 is made of a cellulose material (e.g., a cellulose sponge). In an embodiment, the cleaning mechanism 1323 includes one or more brushes. The brushes can be made of natural fibers such as animal fibers, vegetable fibers, etc. The brushes can be made of synthetic fibers such as nylon, polyester, polypropylene, etc. In an embodiment, the cleaning mechanism 1323 includes an outlet (e.g., nozzle) configured to release pressurized air towards the screen 1322. The cleaning mechanism 1323 can also include a combination of the aforementioned features. For example, in an embodiment, the cleaning mechanism 1323 is made of a microfiber cloth (or cellulose sponge) and includes an outlet configured to release pressurized air. The pressurized air may further include a cleaning solution. Therefore, in an embodiment, the cleaning mechanism 1323 is configured to spray cleaning solution onto the screen 1322.

In an embodiment, the motor 1330 is an electric motor. The motor 1330 can be one of several types of electric motors. For example, in an embodiment, the motor 1330 is an induction motor, such as a split-phase induction motor, capacitor start induction motor, or a squirrel cage induction motor. In an embodiment, the motor 1330 is a permanent magnet motor. The motor 1330 may be an alternating current (AC) or direct current (DC) motor. The motor 1330 may be brushed or brushless. The motor 1330 may be air-cooled and/or liquid-cooled. The motor 1330 can be a single-phase, two-phase, or three-phase motor. The motor 1330 may also be self-commutated or externally commutated. The motor 1330 may be magnetic based, electrostatic based, or piezoelectric based. The motor 1330 includes one or more motor components, such as rotors, bearings, stators, air gaps, windings, and commutators. The motor 1330 is configured to rotate about a first fixed axis of revolution at a fixed speed/revolutions per minute (RPM). For example, in an embodiment, the motor 1330 is configured to rotate at a speed of 1-600 RPMs. The motor 1330 may also be configured rotate at several RPMs according to different speed settings. For example, in an embodiment, the motor 1330 is configured to rotate at a low-speed setting, a medium-speed setting, and a high-speed setting. In an embodiment, the rotational speed of the motor is determined by the AV system 120 according to the amount of detritus that needs to be removed or cleaned from the screen 1322.

The motor 1330 is mechanically coupled to the screen 1322 via the line 1340 such that rotation of the motor 1330 causes the screen 1322 to rotate about a second fixed axis. In an embodiment, the first fixed axis is the same as the second fixed axis of revolution. However, in an embodiment, the sensor housing 1300 includes pulleys positioned such that the first fixed axis and the second fixed axis are different (e.g., opposite or orthogonal). In an embodiment, the line 1340 is a cable. In an embodiment, the line 1340 is a belt. The line 1340 can also be made of rope, cord, string, twine, chain, or any other drive element typically used in a pulley system.

The housing controller circuit 1350 includes, for example, one or more processors (e.g., one or more computer processors such as microprocessors or microcontrollers or both), short-term and/or long-term data storage (e.g., memory random-access memory or flash memory or both), and instructions stored in memory that carry out operations of the housing controller circuit 1350 when the instructions are executed (e.g., by the one or more processors). In an embodiment, the housing controller circuit 1350 is integrated as part of the controller 1102 discussed previously with reference to FIG. 12. In an embodiment, the housing controller circuit 1350 is separate from the controller 1102. The housing controller circuit 1350 is configured to receive sensor data from the sensor 1320 and determine if the sensor 1320 is operating at a reduced accuracy. As described herein, accuracy relates to the amount of uncertainty in a sensor's measurement. In an embodiment, the sensor 1320 operates at a reduced accuracy when dirt, oil, and/or water (snow or rain), debris, leaves, twigs, bird droppings, and residue among other objects and materials accumulate on the screen 1322, causing the sensor 1320 to have a decrease in visibility, adding additional noise, and therefore uncertainty, to the signals detected by the sensor 1320. Determining that the sensor 1320 is operating at a reduced accuracy may include determining that any occlusions exists on the screen 1322 or comparing the current accuracy of the sensor's 1320 measurements to an accuracy threshold (e.g., a desired accuracy). For example, in an embodiment, the housing controller circuit 1350 determines that the sensor 1320 is operating at a reduced accuracy if the housing controller circuit 1350 determines that any occlusions exists on the sensor 1320. In an embodiment, the housing controller circuit 1350 compares the sensor's 1320 accuracy with an accuracy threshold (e.g., an absolute certainty standard), and determines that the sensor 1320 is operating at a reduced accuracy when the sensor's accuracy is below the accuracy threshold.

The housing controller circuit 1350 is also configured to cause the sensor 1320 to enter into a self-cleaning mode based on the determination that the sensor 1320 is operating at a reduced accuracy. During self-cleaning mode, the housing controller circuit 1350 actuates the motor 1330, causing the motor 1330 to rotate, and therefore causing the screen 1322 to rotate. When the cleaning mechanism 1323 is in direct contact with the screen 1322, the cleaning mechanism 1323 wipes (or absorbs) potential accumulated dirt, oil and/or water off the screen 1322 as the screen 1322 rotates. When the cleaning mechanism 1323 includes an actuator member, the housing controller circuit 1350 is configured to control the actuator member to move the cleaning mechanism 1323 towards the screen 1322 so that the cleaning mechanism 1323 can wipe (or absorbs) accumulated dirt, oil and/or water off the screen 1322 as the screen 1322 rotates. The actuator member can also be controlled by the housing controller circuit 1350 to move the cleaning mechanism 1323 vertically and/or horizontally at one or more angles relative to the screen 1322 to further facilitate cleaning of the screen 1322. This movement can further include circular, z-shaped, or figure-eight motions. In an embodiment, the housing controller circuit 1320 is configured to cause the sensor 1320 to enter into a self-cleaning mode periodically, for example, once a day, once a week, etc., as determined by the AV system 120. In an embodiment, the housing controller circuit 1320 is configured to cause the sensor 1320 to enter and remain in self-cleaning mode due to inclement weather or other environmental factors that cause persistent sensor occlusion.

When the cleaning mechanism 1323 includes an outlet for pressurized air, the housing controller circuit 1350 is configured to actuate a release valve to cause the pressurized air to flow through the outlet towards the screen 1322. The air may blow off accumulated dirt, oil and/or water from the screen 1322 as the screen 1322 rotates. As indicated previously, the cleaning mechanism 1323 may include both an outlet for releasing pressurized air along with other cleaning materials such as a microfiber cloth or a cellulose sponge. Also, the pressurized air may further contain cleaning solution. Accordingly, the cleaning mechanism 1323 may spray the screen 1322 with cleaning solution while wiping the screen 1322 with the cloth/sponge.

The housing controller circuit 1350 is configured to cause the sensor 1320 to enter self-cleaning mode for a fixed period of time, or dynamically based on further determinations. For example, in an embodiment, the housing controller circuit 1350 causes the sensor to enter self-cleaning mode for anywhere between 2 to 10 seconds (or longer) when it determines that the sensor 1320 is operating at a reduced accuracy. In an embodiment, the housing controller circuit 1350 is configured to determine the amount of time the sensor 1320 should be in the self-cleaning mode based on the magnitude of reduced accuracy at which the sensor 1320 is operating. For example, at lower accuracies, the housing controller circuit 1350 causes the sensor 1320 to enter self-cleaning mode for longer periods of time. At higher accuracies (but still below an accuracy threshold), the housing controller circuit 1350 causes the sensor 1320 to enter self-cleaning mode for shorter periods of time. In an embodiment, the housing controller circuit 1350 receives sensor data from the sensor 1320 after the sensor 1320 has entered self-cleaning mode for a period of time, and then determines if the sensor 1320 is sufficiently cleaned. This determination can be made by comparing the after self-cleaning accuracy to an accuracy threshold. For instance, in an embodiment, the housing controller circuit 1350 causes the sensor 1320 to begin sensing operations if the self-cleaning accuracy is below the accuracy threshold. If the after self-cleaning accuracy is below or equal to the accuracy threshold, the housing controller circuit 1350 causes the sensor 1320 to enter self-cleaning mode for an additional period of time.

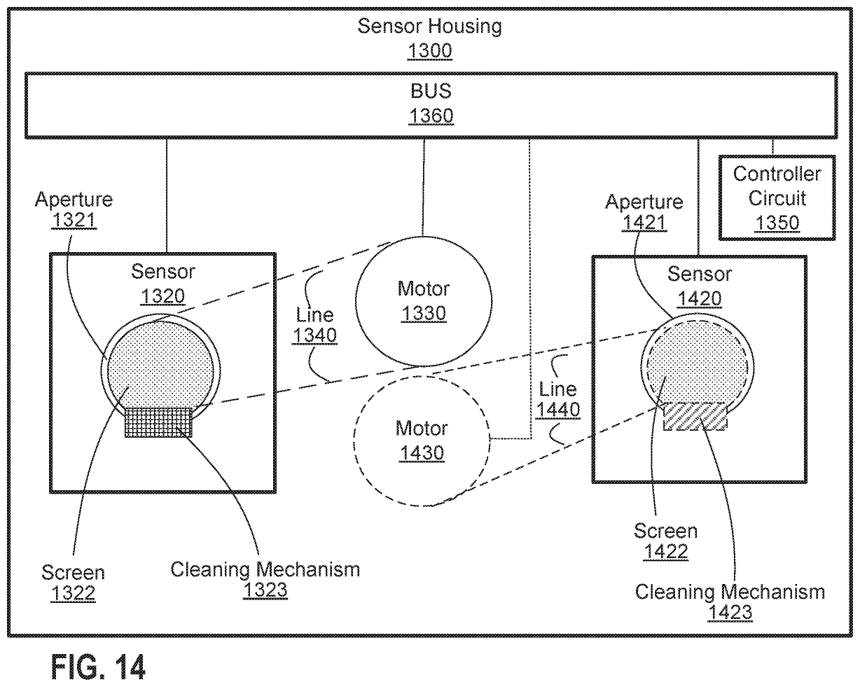

The sensor housing 1300 may include more than one sensor. FIG. 14 illustrates an example of a sensor housing having self-cleaning capability including two sensors, in accordance with one or more embodiments. In this illustrative example, the sensor housing 1300 includes a second sensor 1420. The second sensor 1420 is connected to the BUS 1360 and includes an aperture 1421. In an embodiment, the second sensor 1420 includes a second screen 1422. In an embodiment, the second sensor 1420 includes a second cleaning mechanism 1423. In an embodiment, the sensor housing 1300 further includes a second motor 1430. The second motor 1430 is mechanically coupled to the second screen 1422 via a second line 1440.

The second sensor 1420 can be one of several types of sensing devices. For example, in an embodiment, the second sensor 1320 is one of the sensors 121 discussed previously with reference to FIG. 1. In an embodiment, the sensor 1320 is one or more of the inputs 502a-c as discussed previously with reference to FIG. 5. In an embodiment, the second sensor 1420 is a LiDAR. In an embodiment, the second sensor 1420 is a RADAR. In an embodiment, the second sensor 1420 is a camera. The camera can be a monocular or stereo video camera configured to capture light in the visible, infrared, and/or thermal spectra. In an embodiment, the second sensor 1420 is an ultrasonic sensor. The second sensor 1420 may also include a combination of sensing devices. For example, in an embodiment, the second sensor 1420 includes a camera and a RADAR. The second sensor 1420 may be the same type of sensor as the sensor 1320. For example, in an embodiment, both the second sensor 1420 and the sensor 1320 are cameras. The second sensor 1420 and the sensor 1320 may be different types of sensors. For example, in an embodiment, the second sensor 1420 is a LiDAR and the sensor 1320 is a RADAR. The aperture 1421 may be a lens, a microelectromechanical system (MEMS), or other openings based on the type of sensing device used. For example, in an embodiment, the second sensor 1420 is a camera and the aperture 1421 is a lens. In an embodiment, the second sensor 1420 is a LiDAR and the aperture 1421 is a MEMS. In an embodiment, the second sensor 1420 is a RADAR and the aperture 1421 is a lens.

The second screen 1422 is made of a transparent protective material. For example, in an embodiment, the second screen 1422 is made of an acrylic-based material. In an embodiment, the second screen 1422 is made of PET. In an embodiment, the second screen 1422 is made of TPU. In an embodiment, the second screen 1422 is made of tempered glass. The second screen 1422 can be made of one of several glass or plastic materials, or other transparent materials known to provide protective, scratch resistant benefits. The second screen 1422 may be made out of the same material as the screen 1322. For example, in an embodiment, the second screen 1422 and the screen 1322 are made of an acrylic-based material. The second screen 1422 and the screen 1322 can also be made of different materials. For example, in an embodiment, the second screen 1422 is made of PET and the screen 1322 is made of tempered glass.

The second cleaning mechanism 1423 is configured to contact the second screen 1422. The second cleaning mechanism 1423 can contact the second screen 1422 directly or indirectly. For example, in an embodiment, the second cleaning mechanism 1423 is in direct contact with the second screen 1422. In an embodiment, the second cleaning mechanism 1423 is at a close distance to the second screen 1422, but is not contacting the second screen 1422 directly. In an embodiment, the second cleaning mechanism 1423 includes an actuator configured to move the second cleaning mechanism 1423 towards and away from the second screen 1422, such that the second cleaning mechanism 1423 can move to a first predefined position that allows the second cleaning mechanism 1423 to directly contact the second screen 1422 and move to a second predefined position where the second cleaning mechanism 1423 is not in direct contact with the second screen 1422. In an embodiment, the actuator member is integrated with the second sensor 1420 and is controlled by the housing controller circuit 1350.

The second cleaning mechanism 1423 can be made out of several types of materials. For example, in an embodiment, the second cleaning mechanism 1423 is made of a microfiber material (e.g., a microfiber cloth). In an embodiment, the second cleaning mechanism 1423 is made of a cellulose materials (e.g., a cellulose sponge). In an embodiment, the second cleaning mechanism 1423 includes one or more brushes. The brushes may be made of natural fibers such as animal fibers, vegetable fibers, etc. The brushes may be made of synthetic fibers such as nylon, polyester, polypropylene, etc. In an embodiment, the second cleaning mechanism 1423 includes an outlet configured to release pressurized air towards the second screen 1422. The second cleaning mechanism 1423 can also include a combination of the aforementioned features. For example, in an embodiment, the second cleaning mechanism 1423 includes a microfiber cloth (or cellulose sponge) and an outlet configured to release pressurized air. The pressurized air may further include a cleaning solution. Therefore, in an embodiment, the second cleaning mechanism 1423 is configured to spray cleaning solution onto the second screen 1422.

The second motor 1430 is connected to the BUS 1360. In an embodiment, the second motor 1430 is an electric motor. The second motor 1430 can be one of several types of electric motors. For example, in an embodiment, the second motor 1430 is an induction motor, such as a split-phase induction motor, capacitor start induction motor, or a squirrel cage induction motor. In an embodiment, the second motor 1430 is a permanent magnet motor. The second motor 1430 may be an alternating current (AC) or direct current (DC) motor. The second motor 1430 may be brushed or brushless. The second motor 1430 may be air-cooled and/or liquid-cooled. The second motor 1430 can be a single-phase, two-phase, or three-phase motor. The second motor 1430 may also be self-commutated or externally commutated. The second motor 1430 may be magnetic based, electrostatic based, or piezoelectric based.

The second motor 1430 includes one or more motor components, such as rotors, bearings, stators, air gaps, windings, and commutators. The second motor 1430 is configured to rotate about a third fixed axis at a fixed speed/revolutions per minute (RPM). For example, in an embodiment, the second motor 1430 is configured to rotate at a speed of 1 to 600 RPMs. The second motor 1430 may also be configured rotate at several RPMs according to different speed settings. For example, in an embodiment, the second motor 1430 is configured to rotate at a low-speed setting, a medium-speed setting, and a high-speed setting. The second motor 1430 may be the same type of motor as the motor 1330, or the second motor 1430 and the motor 1330 can be different types of motors. The second motor 1430 and the motor 1330 can be configured to rotate and the same speeds or different speeds. The third fixed axis may be the same as the first fixed axis or it may be different than the first fixed axis.

The second motor 1430 is mechanically coupled to the second screen 1422 via the second line 1440 such that rotation of the second motor 1430 causes the second screen 1422 to rotate about a fourth fixed axis. In an embodiment, the third fixed axis is the same as the fourth fixed axis. However, in an embodiment, the sensor housing 1300 includes pulleys positioned such that the third fixed axis and the fourth fixed axis are different (e.g., opposite). In an embodiment, the second line 1440 is a cable. In an embodiment, the second line 1440 is a belt. The second line 1440 can also be made of rope, cord, string, twine, chain, or any other drive element typically used in a pulley system. The second line 1440 and the line 1340 may be made of the same material or different materials.

As indicated above, the housing controller circuit 1350 is configured to determine if the sensor 1320 is operating at a reduced accuracy. When the second sensor 270 is included, the housing controller circuit 1350 may be configured to turn the second sensor 1420 off or on based on the determination that the sensor 1320 is operating at a reduced accuracy. For example, in an embodiment, the housing controller circuit 1350 turns the second sensor 1420 on when it causes the sensor 1320 to enter the self-cleaning mode. Therefore, while the motor 1330 is activated, and thus sensor 1320 is in the self-cleaning mode, the second sensor 220 may begin performing sensing operations.

The housing controller circuit 1350 is also configured to cause the second sensor 1420 to enter a self-cleaning mode based on the determination that the second sensor 1420 is operating at a reduced accuracy. Determining that the second sensor 1420 is operating at a reduced accuracy may include determining that any occlusions exists on the screen 1422 or comparing the current accuracy of the second sensor 1420 to an accuracy threshold (e.g., a desired accuracy). For example, in an embodiment, the housing controller circuit 1350 determines that the second sensor 1420 is operating at a reduced accuracy if the housing controller circuit 1350 determines that any occlusions exists in the second sensor's 1320 field of view. In an embodiment, the housing controller circuit 1350 compares the second sensor's 1420 accuracy with an accuracy threshold (e.g., an absolute certainty standard), and determines that the second sensor 1420 is operating at a reduced accuracy when the sensor's accuracy is below the accuracy threshold.

During self-cleaning mode, the housing controller circuit 1350 actuates the second motor 1430, causing the second motor 1430 to rotate, and therefore causing the second screen 1422 to rotate. When the second cleaning mechanism 1423 is in direct contact with the second screen 1422, the second cleaning mechanism 1423 wipes potential accumulated dirt, water and/or oil off the second screen 1422 as the second screen 1422 rotates. When the second cleaning mechanism 1423 includes an actuator member, the housing controller circuit 1350 is configured to control the actuator member to move the second cleaning mechanism 1423 towards the second screen 1422 so that the second cleaning mechanism 1423 can wipe (or absorb) accumulated dirt, oil and/or water off the second screen 1422 as the second screen 1422 rotates. The actuator member can also be controlled by the housing controller circuit 1350 to move the cleaning mechanism 1423 vertically and/or horizontally at one or more angles relative to the second screen 1422 to further facilitate cleaning of the second screen 1422. This movement can further include circular, z-like, or figure-eight motions. When the second cleaning mechanism 1423 includes an outlet for pressurized air, the housing controller circuit 1350 is configured to actuate a release valve to cause the pressurized air to flow through the outlet towards the second screen 1422. The air may blow off accumulated dirt, oil and/or water from the second screen 1422 as the second screen 1422 rotates. As indicated previously, the second cleaning mechanism 1423 may include both an outlet for releasing pressurized air along with other cleaning materials such as a microfiber cloth or a cellulose sponge. Also, the pressurized air may further contain cleaning solution. Accordingly, the second cleaning mechanism 1423 may spray the second screen 1422 with cleaning solution while wiping the second screen 1422 with the cloth/sponge.

The housing controller circuit 1350 may be configured to cause the second sensor 1420 to enter self-cleaning mode for a fixed period of time or dynamically based on further determinations. For example, in an embodiment, the housing controller circuit 1350 causes the second sensor 1420 to enter self-cleaning mode for anywhere between 2 to 10 seconds (or longer) when it determines that the second sensor 1420 is operating at a reduced accuracy. In an embodiment, the housing controller circuit 1350 is configured to determine the amount of time the second sensor 1420 should be in the self-cleaning mode based on the magnitude of reduced accuracy at which the second sensor 1420 is operating. For example, at lower accuracies, the housing controller circuit 1350 causes the second sensor 1420 to enter self-cleaning mode for longer periods of time. At higher accuracies (but still below an accuracy threshold), the housing controller circuit 1350 causes the second sensor 1420 to enter self-cleaning mode for shorter periods of time. In an embodiment, the housing controller circuit 1350 receives sensor data from the second sensor 1420 after the second sensor 1420 has entered self-cleaning mode for a period of time, and then determines if the second sensor 1420 is sufficiently cleaned. This determination can be made by comparing the after self-cleaning accuracy to an accuracy threshold. For instance, in an embodiment, the housing controller circuit 1350 causes the second sensor 1420 to begin sensing operations if the after self-cleaning accuracy is above the accuracy threshold. If the after self-cleaning accuracy is below or equal to the accuracy threshold, the housing controller circuit 1350 causes the second sensor 1420 to enter self-cleaning mode for an additional period of time.

In an embodiment, the housing controller circuit 1350 never causes both sensors 1320, 1420 to enter the self-cleaning mode at the same time. Therefore, sensing operations are conducted by one of the sensors. In an embodiment, the housing controller circuit 1350 determines that both sensors 1320, 1420 are operating at a reduced accuracy and as a result the housing controller circuit 1350 is configured to determine which of the sensors is operating at lower accuracy. For example, assume that the sensor 1320 is operating at a lower accuracy than the second sensor 1420. The housing controller circuit 1350 causes the sensor 1320 to enter self-cleaning mode while causing the second sensor 1420 to continue to operate. Once the housing controller circuit 1350 determines that the sensor 1320 is sufficiently clean, the housing controller circuit 1350 can cause the sensor 1320 to resume operations while causing the second sensor 1420 to enter self-cleaning mode. Once the housing controller circuit 1350 determines that the second sensor 1420 is sufficiently clean, the housing controller circuit 1350 can cause the second sensor 1420 to being sensing operations or power-down the second sensor 1420.

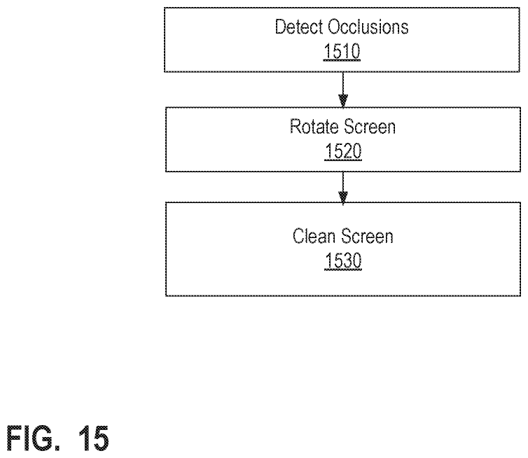

FIG. 15 is a flow diagram depicting an exemplary method 1500 for performing self-cleaning operations, in accordance with one or more embodiments. For illustrative purposes, the method 1500 is performed by the sensor housing 1300 according to FIG. 13. However, the method 1500 can be performed by any sensor housing or sensor system capable of performing self-cleaning operations, including the sensor housing 1300 referenced in FIG. 14. The method 1500 includes detecting occlusions (block 1510), rotating a screen (block 1520), and cleaning the screen (block 1530).

At block 1510, sensor 1320 detects occlusions. As the sensor 1320 is operating, the housing controller circuit 1350 is receiving sensor data from the sensor 1320. The housing controller circuit 1350 is determining, based on the received sensor data, if the sensor 1320 is operating at a reduced accuracy. The sensor 1320 may be operating at a reduced accuracy due to occlusions caused by dirt, oil, and/or water accumulation on the screen 1322. Determining that the sensor 1320 is operating at a reduced accuracy may include determining that any occlusions exists on the screen 1322 or comparing the current accuracy of the sensor 1320 to an accuracy threshold or previously stored sensor data. For example, in an embodiment, the housing controller circuit 1350 determines that the sensor 1320 is operating at a reduced accuracy if the housing controller circuit 1350 determines that sensor 1320 is occluded. In an embodiment, the housing controller circuit 1350 compares the sensor's 1320 accuracy with an accuracy threshold, and determines that the sensor 1320 is operating at a reduced accuracy when the sensor's accuracy is below an accuracy threshold. In an embodiment, the accuracy threshold is determined according to statistical analysis or statistical treatment of historical sensor data. In an embodiment, the accuracy threshold is determined according to the minimum accuracy of sensor 1320 for operating the AV 100.

At block 1520 the sensor 1320 rotates the screen 1322. As indicated above with reference to FIG. 13, the sensor 1320 includes a screen 1322 that fully or partially covers the aperture 1321. The screen 1322 is mechanically coupled to the motor 1330 by the line 1340. When the housing controller circuit 1350 determines that the sensor 1320 is operating at a reduced accuracy, the housing controller circuit actuates the motor 1330. This causes the motor 1330 to rotate, and in turn, causes the screen 1322 to rotate.

At block 1530, the screen 1322 is cleaned by the cleaning mechanism 1323. As indicated above with reference to FIG. 13, the sensor 1320 includes a cleaning mechanism 1323. The cleaning mechanism 1323 may be in direct contact with the screen 1322, and thus can clean the screen 1322 while it is rotating by wiping (or absorbing) dirt, oil, and/or water off the screen 1322. For example, in an embodiment, the cleaning mechanism 1323 is a microfiber cloth or a cellulose sponge that is in direct contact with the screen 1322. As the screen 1322 rotates, the cloth/sponge wipes (or absorbs) dirt, oil, and/or water that has accumulated on the screen 1322. The cleaning mechanism may also be positioned in close proximity to the screen 1322 and include an actuator member to move the cleaning mechanism 1323 towards the screen 1322. In this instance, the housing controller circuit 1350 controls the actuator member to cause the cleaning mechanism 1323 to move towards and contact the screen 1322 when the screen 1322 is rotating. Thus, the cleaning mechanism 1323 may only contact the screen 1322 when the screen 1322 is being cleaned.

The cleaning mechanism may also include an outlet to release pressurized air towards the screen 1322. In this instance, the housing controller circuit 1350 actuates a release valve such that the pressurized air is released through the outlet of the cleaning mechanism 1323 towards the screen 1322. The pressurized air can blow the dirt, oil and/or water off the screen 1322 as the screen 1322 rotates. The pressurized air can also include a cleaning solution. The cleaning mechanism 1323 can be one, all, or a combination of the cloth/sponge, actuator member and outlet. For example, in an embodiment, the cleaning mechanism 1323 includes a cloth/sponge and an outlet for releasing pressurized air containing a cleaning solution. In this instance, the cleaning mechanism 1323 sprays the screen 1322 with the cleaning solution while wiping (or absorbing) dirt, oil, and/or water from the screen 1322.

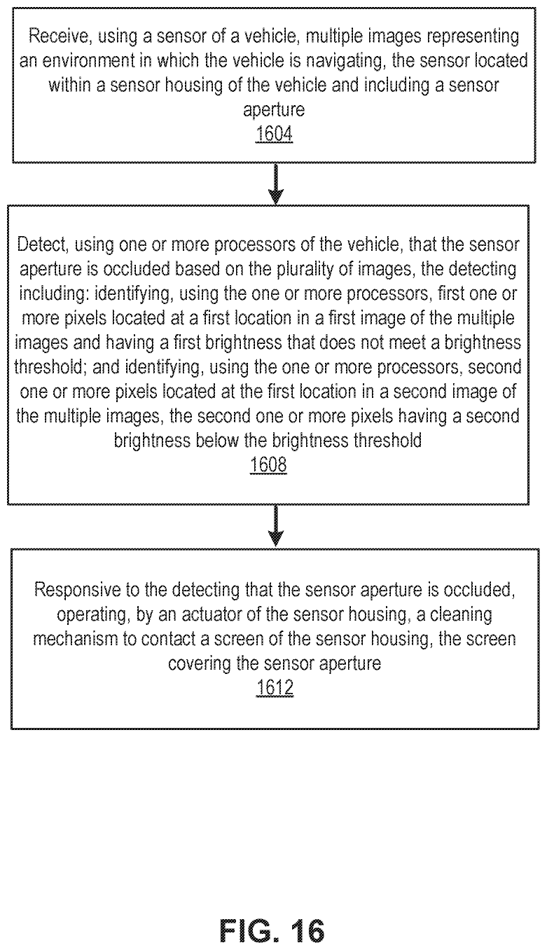

FIG. 16 is a flow diagram illustrating a method for determining whether debris is blocking a sensor aperture. In some embodiments, the method is performed by the computer processors 146 illustrated and described in more detail with reference to FIG. 4.

In step 1604, a sensor (for example, the sensor 1320 shown in FIG. 13) of a vehicle (for example, the AV 100 shown in FIG. 1) is used to receive multiple images representing an environment (for example, the environment 190 shown in FIG. 1) in which the AV 100 is operating. The sensor 1320 is located within a sensor housing (for example, the sensor housing 1300 shown in FIG. 13) of the AV 100. A13. The sensor housing 1300 can be made of engineering plastic, metal, or fiberglass. The sensor 1320 includes a sensor aperture.

In step 1608, the one or more processors 146 of the AV 100 detect that the sensor aperture is occluded based on the multiple images. The detecting includes identifying, using the one or more processors 146, first one or more pixels located at a first location in a first image of the multiple images. The first one or more pixels have a first brightness that does not meet a brightness threshold. For example, the first one or more pixels can correspond to debris, snow, or water, and therefore appear darker than other pixels. The processors 146 identify second one or more pixels located at the first location in a second image of the multiple images. The second one or more pixels have a second brightness that also does not meet the brightness threshold.

The number of darker pixels that correspond to occluded portions of the sensor can increase as a size of the aperture decreases. In an embodiment, the first image is associated with a first size of the sensor aperture. The second image is associated with a second size of the sensor aperture smaller than the first size. A number of the first one or more pixels is smaller than a number of the second one or more pixels. For example, the number of occluded pixels increases as a size of the sensor aperture decreases between the first image and the second image. The debris is captured in the same part of the images even when the image is of different scenes.

In an embodiment, machine learning is used to detect that the sensor aperture is occluded. For example, the one or more processors 146 transmit the first image and the second image to a machine learning model trained to determine whether the sensor aperture is occluded based on pixels in an image received using the sensor 1320. The machine learning model is used to determine that the sensor aperture is occluded based on the first one or more pixels and the second one or more pixels.

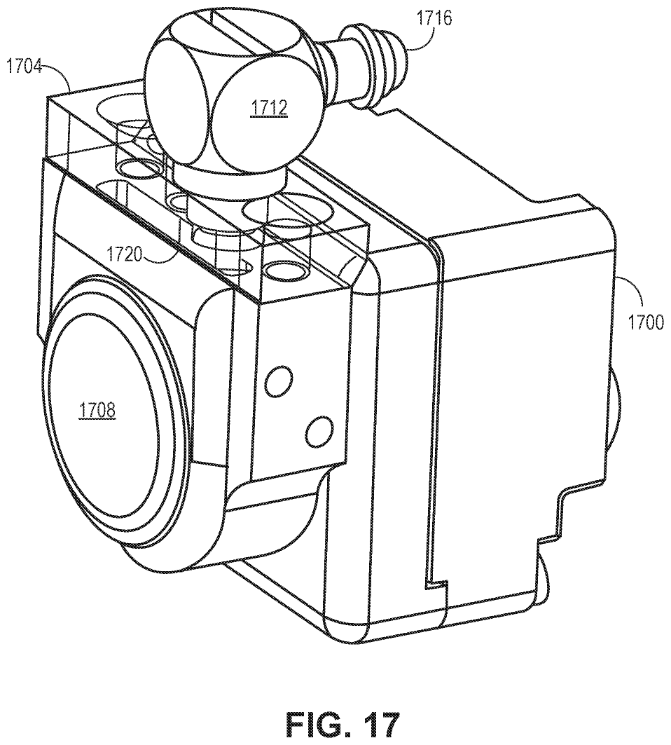

In step 1612, responsive to the detecting that the sensor aperture is occluded, an actuator (for example, the actuator member described in more detail with reference to FIG. 13) of the sensor housing 1300 operates a cleaning mechanism (for example, the cleaning mechanism 1323 shown in FIG. 13). The cleaning mechanism 1323 contacts a screen (for example, the screen 1322 shown in FIG. 13) of the sensor housing 1300. The screen 1322 covers the sensor aperture. For example, the cleaning mechanism 1323 can be an air knife of compressed air, a piece of fabric, or a wiper blade. In an embodiment, the cleaning mechanism 1323 includes an air knife emitted by an outlet slot of an air chamber located within the sensor housing 1300 of the AV 100. Such an air knife is illustrated and described in more detail with reference to FIG. 17. The air chamber can be shaped to contain pressurized air from an air pump. The air chamber includes an inlet shaped to allow the pressurized air to enter the air chamber and an outlet slot shaped to emit the compressed air in a manner to prevent occlusion of the sensor 1320.

In an embodiment, the operating of the cleaning mechanism 1323 includes moving, by the actuator member of the sensor housing 1300, the cleaning mechanism 1323 to wipe debris, snow, or water from the screen 1322. For example, the actuator member of the sensor housing 1300 can move the cleaning mechanism 1323 in at least one of a circular motion, a z-shaped motion, or a figure-of-8 motion.

In an embodiment, the operating of the cleaning mechanism 1323 includes controlling a motor (for example, the motor 1330 shown in FIG. 13) of the sensor housing 1300 to move the cleaning mechanism 1323. The motor 1330 of the sensor housing 1300 can be air-cooled or liquid-cooled. The motor 1330 of the sensor housing 1300 can be self-commutated or externally commutated. The motor 1330 of the sensor housing 1300 can be a split-phase induction motor, a capacitor start induction motor, or a squirrel cage induction motor.

In an embodiment, an audio sensor, such as an on-board microphone of the AV 100 can be occluded. The audio sensor can become occluded, for example, if debris is sticking to a grill or cover of the audio sensor. The processors 146 detect that the audio sensor of the AV 100 is occluded based on a hash of frequencies of peak points of audio signals captured by the audio sensor. The perception module 402 can determine the characteristics of an object by generating a hash of peaks in a spectrogram of the acoustic signals. The hash of peaks is a function used to map the points of peak amplitude in the spectrogram onto hash values or hash codes. The perception module 402 determines salient points in each region of the spectrogram that are not a result of background noise. In an embodiment, the perception module 402 generates the hash of peaks by segregating the spectrogram into zones and generating the hash value for each peak pair in the zone. The perception module 402 determines whether the audio sensor is occluded based on the hash values

In an embodiment, the processors 146 detect that an audio sensor of the AV 100 is occluded based on spectral flatness, prominent tones across a set of frequency bands, or bandwidth tracking. For example, the perception module 402 identifies occlusion by determining a spectral flatness of the audio signals. The spectral flatness (also sometimes known as the tonality coefficient) is measured in decibels and quantifies the amount of peaks or resonant structure in the power spectra of the audio signals. Prominent tones in a spectrogram across a set of frequency bands and bandwidth tracking can also be used by the processors 146. The actuator member of the sensor housing 1300 can operate an air nozzle to clean the audio sensor of the AV 100 when the processors 146 detect that the audio sensor is occluded and that the audio sensor is turned off.

FIG. 17 illustrates a sensor housing 1700 of a vehicle (for example, the AV 100 shown in FIG. 1). The sensor housing 1700 includes a sensor casing 1704. B3. The sensor casing 1704 can be made of engineering plastic, metal, or fiberglass and mounted on the AV 100. The sensor casing 1704 includes a sensor of the AV 100. For example, the sensor can be a camera or a microphone. In the embodiment illustrated with reference to FIG. 17, a visual sensor is envisioned. The sensor casing 1704 includes a screen 1708 covering at least a portion of the sensor.

An air chamber 1712 is mounted on the sensor casing 1704. The air chamber 1712 can be made of engineering plastic, metal, or fiberglass and attached to the sensor casing 1704. The air chamber 1712 is shaped to contain pressurized air for cleaning the screen 1708 to prevent occlusion of the sensor within the sensor casing 1704. The air chamber 1712 includes an inlet 1716 shaped to allow the pressurized air to enter the air chamber 1712. The air chamber 1712 includes an outlet slot 1720 shaped to emit the compressed air in a manner to prevent occlusion of the sensor. In an embodiment, the outlet slot 1720 is excised by a computer numerical control (CNC) machine tool during manufacturing. The compressed air prevents occlusion of the sensor by wiping debris, snow, or water off the screen 1708 of the sensor. The occlusion can be caused by snow, dust, ice, or water droplets. Thus, occlusion of the sensor is prevented by the emitted compressed air wiping or blowing debris, snow, or water off the screen. In some embodiments, the outlet slot 1720 is referred to as an “air nozzle.” In an embodiment, the emitted pressurized air directly cleans the lens within the sensor casing 1704. The emitted pressurized air is angled towards the center of the lens, which has a rounded shape. The air chamber 1712 is integrated with the sensor casing 1704. For example, the air chamber 1712 can be mounted on a side of the position of the outlet slot 1720, such that the air chamber 1712 is flexible in orientation.

The outlet slot 1720 shapes the pressurized air emitted by the outlet slot 1720 into an air knife. The knife is a high-intensity, uniform sheet of laminar airflow across the surface of the screen 1708. For example, when a lens inside the sensor casing 1704 is convex, the air knife travels along the periphery of the screen 1708. The velocity of the pressurized air exiting the outlet slot 1720 can create an impact air velocity onto the surface of the screen 1708. In an embodiment, the outlet slot 1720 is grooved. In another embodiment, the outlet slot 1720 includes an air knife modulator. The air knife modulator receives the pressurized air in the form of the air knife from the outlet slot 1720 and directs the air knife such that the air knife follows a particular channel towards the screen 1708. The outlet slot 1720 is shaped to emit the pressurized air to wipe debris, water, or snow from a surface of the screen 1708.

In an embodiment, the sensor within the sensor housing 1704 includes a fisheye lens and the screen 1708 has a convex shape. For example, the sensor can be an Omnivision Fisheye Field of View camera. The pressurized air emitted by the outlet slot 1720 bends outward to follow the convex shape of the screen 1708. For example, the air knife modulator itself can have grooves to shape the air knife in a channel corresponding to a curvature of the lens and the screen 1708.

The sensor housing 1700 can be configured to emit the air knife at different pressures. In an embodiment, the sensor housing is configured to emit the pressurized air at a pressure in a range from 1 MPa to 0.1 MPa. The air knife can be emitted in timed bursts from the outlet slot 1720. In an embodiment, the sensor housing 1720 is configured to emit the pressurized air in bursts in a range from 0.01 seconds to 0.1 seconds. The sensor housing can be calibrated to emit a particular volume of the pressurized air during a single cleaning event. In an embodiment, a volume of the pressurized air emitted by the outlet slot is in a range from 30 liters to 200 liters over multiple bursts.

The sensor housing 1700 can be calibrated to receive the pressurized air from an on-board air pump and motor at a particular rate. In an embodiment, the air chamber is sized to receive the pressurized air at a rate in a range from 0.5 CFM to 2 CFM. The sensor housing 1700 can be calibrated to emit the pressurized air at a particular rate. For example, the air chamber is sized such that pressurized air is emitted at a rate in a range from 1 liter/second to 3 liter/second. The shape and width of the air knife is varied in accordance with a width of the screen. For example, the width of the screen can be in a range from 15 mm to 45 mm. The air knife can also diverge as it exits the outlet slot 1720. In an embodiment, the outlet slot 1720 is shaped to emit the pressurized air at an outlet angle in a range from 90° to 179°.

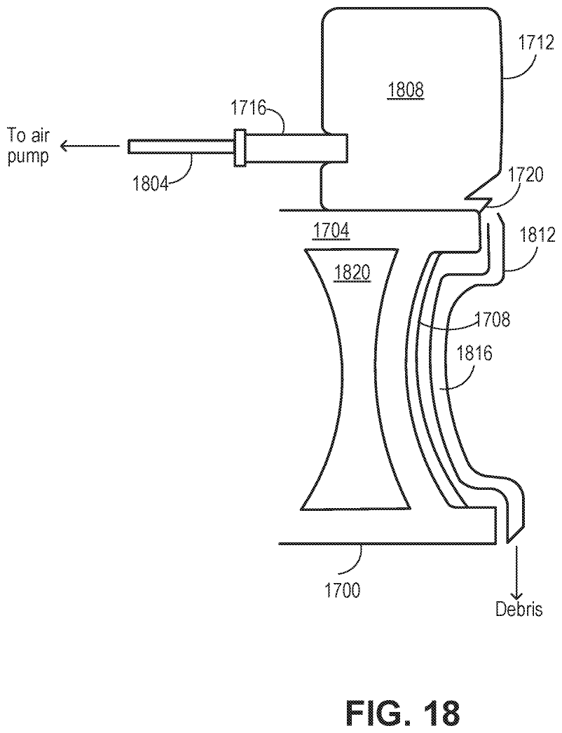

FIG. 18 illustrates a section of a sensor housing 1700 of a vehicle (for example, the AV 100 shown in FIG. 1). The sensor housing 1700 includes the sensor casing 1704, which includes the sensor depicted in FIG. 18 by the lens 1820. The screen 1708 covers at least a portion of the sensor 1820. The air chamber 1712 is mounted on the sensor casing 1704. The air chamber 1712 is shaped to contain pressurized air 1808. The air chamber 1712 includes an inlet 1716 shaped to allow the pressurized air 1808 to enter the air chamber 1712. The outlet slot 1720 is shaped to emit the compressed air 1808 in a manner to prevent occlusion of the sensor 1820. The compressed air 1808 can prevent occlusion of the sensor 1820 by wiping debris, snow, or water off the screen 1708 of the sensor 1820.

In an embodiment, the inlet 1716 is shaped to receive the pressurized air 1808 via a tubing 1804 having a first end and a second end. The first end of the tubing is operably coupled to the inlet 1716. For example, the tubing 1804 can be clamped to or inserted into the inlet 1716. The second end of the tubing 1804 is operably coupled to an air pump driven by a motor. The air pump is configured to pump the pressurized air 1808 via the tubing 1804 towards the inlet 1716.

The pressurized air 1808 emitted by the outlet slot 1720 follows a laminar path 1816 parallel to a surface of the screen 1708. For example, an air knife modulator of the outlet slot 1720 or grooves in the outlet slot 1720 can shape the air knife 1812 into a channel corresponding to a shape of the sensor housing 1700. In an embodiment, the screen 1708 has a concave shape. For example, the sensor can be an Omnivision Narrow Field of View camera. The air knife 1812 emitted by the outlet slot 1720 bends inward to follow the concave shape of the screen 1708. For example, the field of view of the sensor 1820 is thus unobstructed by the air chamber 1712. In an embodiment, the outlet slot 1720 is shaped to emit the air knife 1812 in spaced relationship with a surface of the screen 1708. For example, the sensor 1820 can include a lens having an aperture. The air knife modulator adapts the channel of the air knife 1812 in accordance with a curvature of the lens.

The shape of the outlet slot 1720 can be designed to modulate the air knife 1812. In an embodiment, a thickness of the outlet slot 1720 is in a range from 0.01 mm to 1 mm. The outlet slot 1720 can modulate the width of the air knife 1812. In an embodiment, a width of the air knife is in a range from 30 mm to 60 mm.

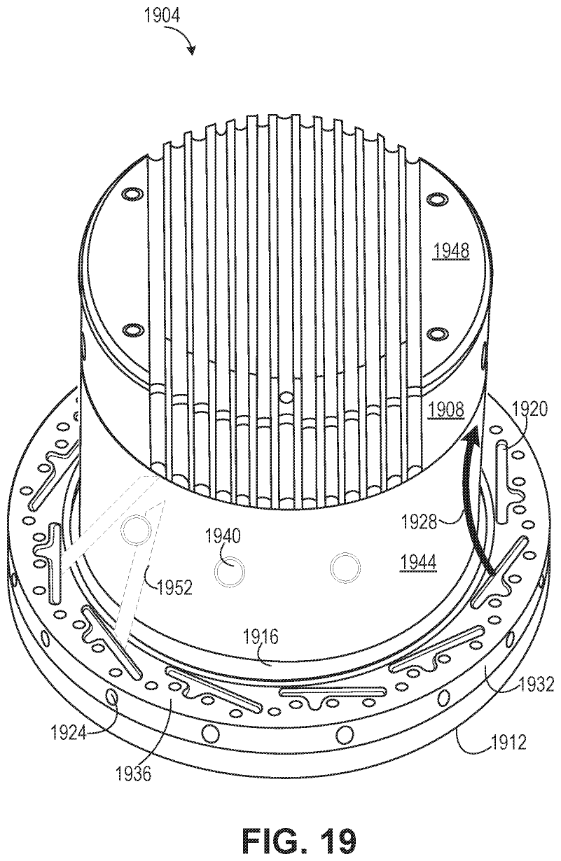

FIG. 19. illustrates a LiDAR housing 1904. The LiDAR housing 1904 is sometimes referred to as a LiDAR sensor housing. The LiDAR housing 1904 is made of at least one of engineering plastic, metal, or fiberglass. The LiDAR housing 1904 includes a LiDAR casing 1908 having a cylindrical shape. The LiDAR casing 1908 is a protective cover or shell that encloses and protects multiple LiDAR sensors 1940. The multiple LiDAR sensors 1940 are disposed in a spaced configuration along a peripheral surface 1944 of the LiDAR casing 1908. For example, a spacing between each consecutive pair of LiDAR sensors 1940 can be designed for an efficient field of view of the environment. The LiDAR casing 1908 is made of at least one of engineering plastic, metal, or fiberglass.

The LiDAR housing 1904 further includes an air chamber 1912 mounted on a base 1916 of the LiDAR casing 1908. The air chamber 1912 is shaped to contain pressurized air 1952. The air chamber 1912 is made of at least one of engineering plastic, metal, or fiberglass. The air chamber 1912 includes multiple inlets 1924 shaped to allow the pressurized air 1952 to enter the air chamber 1912. For example, each inlet 1924 is an opening or hole on an external surface of the air chamber 1912 through which the pressurized air 1952 is inserted into the air chamber 1912. In some embodiments, the multiple inlets 1924 are sized to receive the pressurized air 1952 at a rate in a range from 0.1 MPa to 1 MPa. In some embodiments, each inlet 1924 is shaped to receive the pressurized air 1952 via a respective tubing (for example, the tubing 1804 shown in FIG. 18) having a first end and a second end. The first end of the tubing 1804 is operably coupled to the inlet 1924, as illustrated and described in more detail with reference to FIG. 18. The second end of the tubing 1804 is operably coupled to an air pump driven by a motor. The air pump is configured to pump the pressurized air 1952 via the tubing 1804 towards the inlet 1924.

The air chamber 1912 further includes multiple outlet slots 1920 disposed along a periphery of the air chamber 1912. In some embodiments, the air chamber 1912 has a flange shape. For example, the air chamber 1912 forms a projecting flat rim, collar, or rib on the base 1916 of the LiDAR casing 1908 to attach to and maintain a position on the base 1916 of the LiDAR casing 1908. The air chamber 1912 forms a conduit 1932 for the pressurized air 1952 to flow from the multiple inlets 1924 to the multiple outlet slots 1920.

In some embodiments, each outlet slot can be independently controlled to emit the pressurized air 1952 in the form of an air knife to wipe or clean the surface 1944 of the LiDAR casing 1908. For example, one or more of the outlet slots 1920 can be turned off to clean only a portion of the surface 1944 of the LiDAR casing 1908. Each outlet slot 1920 is shaped to emit a respective portion of the pressurized air 1952 in a manner to prevent occlusion of one or more LiDAR sensors 1940. For example, each outlet slot 1920 can receive compressed air via a respective tubing 1804 from an air pump driven by a motor, as illustrated and described in more detail with reference to FIG. 18. The LiDAR housing 1904 can be configured to turn off one or more outlet slots 1920 to prevent one or more corresponding portions of the pressurized air 1952 from being emitted. In this manner, the multiple outlet slots 1920 can reduce use of the pressurized air 1952. The LiDAR images can be monitored to determine where debris lies (as illustrated and described in more detail with reference to FIG. 16), and only a particular one or more outlet slots 1920 can be utilized to save the pressurized air 1952 by cleaning only some LiDAR sensors 1940.

Each outlet slot 1920 is shaped to emit a respective portion of the pressurized air 1952 in a direction 1928 across the peripheral surface 1944 of the LiDAR casing 1908. For example, each air knife can follow a direction from a base 1916 of the LiDAR casing 1908 towards a top 1948 of the LiDAR casing 1908. In such a manner, the multiple air knives remove a material occluding the multiple LiDAR sensors 1940. For example, the material can be snow, water, or debris. The pressurized air knife 1952 blows dust, snow, or water off the LiDAR casing 1908 as it exits the cylindrical surface 19552 of the LIDAR casing 1908. In some embodiments, the outlet slots 1920 are positioned and shaped, such that the pressurized air 1952 exits the LiDAR housing 1904 diverging tangentially from the peripheral surface 1944 of the LiDAR casing 1908. The pressurized air knife 1952 is thus angled to exit the cylindrical surface 19552 of the LIDAR casing 1908 and not simply blow straight upwards to the top 1948. C20. In some embodiments, a length of each outlet slot 1920 is in a range from 20 mm to 60 mm.

Each outlet slot 1920 is spaced apart from a successive outlet slot. A spacing between each consecutive pair of outlet slot 1920 can be designed for efficient cleaning of the peripheral surface 1944 of the LiDAR casing 1908. In some embodiments, the multiple outlet slots 1920 are shaped to emit the pressurized air 1952 in a reticulated pattern. For example, the multiple air knives generated form a pattern of interlacing cones. The outlet slots 1920 can be angled to create multiple, intersecting cones of the pressurized air 1952. For example, the multiple outlet slots are positioned such that they emit multiple, intersecting portions of the pressurized air 1952. Thus, each pressurized air knife 1952 can overlap with another pressurized air knife to clean an area located between each pair of outlets 1920. The multiple, intersecting cones of the pressurized air 1952 thus clean debris, water, or snow that occludes one or more LiDAR sensors 1940.

In some embodiments, each outlet slot 1920 is shaped to emit a respective portion of the pressurized air 1952 oblique to a plane defined by a surface 1936 of the air chamber 1912. The direction oblique to the plane defined by the surface 1936 corresponds to the direction 1928. In some embodiments, a thickness of each outlet slot 1920 is in a range from 0.01 mm to 1 mm. In some embodiments, the LiDAR housing 1904 is configured to emit the pressurized air 1952 in multiple, successive bursts. For example, the multiple, successive bursts can be timed in a range from 0.01 seconds to 0.1 seconds.

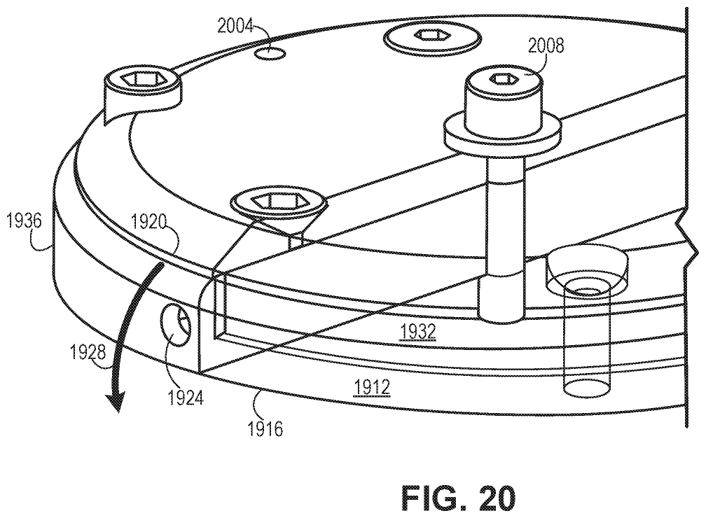

FIG. 20 illustrates a section of a LiDAR sensor housing (for example, the LiDAR sensor housing 1904 shown in FIG. 19.) The LiDAR housing 1904 includes a LiDAR casing (for example, the LiDAR casing 1908). An air chamber 1912 is mounted on a base 1916 of the LiDAR casing 1908. The LiDAR housing 1904 includes bolts 2008 to secure the air chamber 1912 to the base 1916 of the LiDAR casing 1908. For example, M6 bolts can be used.

The air chamber 1912 is shaped to contain pressurized air. The air chamber 1912 includes multiple outlet slots 1920 disposed along a periphery of the air chamber 1912. In an embodiment, one or more of the outlet slots 1920 can be turned off to clean only a portion of the LiDAR casing 1908. Each outlet slot 1920 is shaped to emit a respective portion of the pressurized air in a manner to prevent occlusion of one or more LiDAR sensors. The outlet slot 1920 can receive compressed air via a conduit 1932 filled by a tubing from an air pump driven by a motor. The LiDAR housing 1904 includes multiple inlets 1924, 2004 shaped to allow the pressurized air to enter the air chamber 1912 from the tubing.

The air chamber 1912 forms a conduit 1932 for the pressurized air to flow from the inlets 1924, 2004 to the outlet slots 1920. Each outlet slot 1920 is shaped to emit a respective portion of the pressurized air oblique to a plane defined by a surface 1936 of the air chamber 1912. Each outlet slot 1920 is shaped to emit a respective portion of the pressurized air in a direction 1928 across a peripheral surface of the LiDAR casing. Each air knife generated follows a direction from the base 1916 of the LiDAR casing 1908 towards a top of the LiDAR casing 1908, such that the multiple air knives remove a material occluding the LiDAR sensors. The material can be snow, water droplets, or debris.

### Additional Embodiments

In an embodiment, a sensor of a vehicle is used to receive multiple images representing an environment in which the vehicle is operating. The sensor is located within a sensor housing of the vehicle. The sensor includes a sensor aperture. One or more processors of the vehicle detect that the sensor aperture is occluded based on the multiple images. The detecting includes identifying first one or more pixels located at a first location in a first image of the multiple images. The first one or more pixels have a first brightness that does not meet a brightness threshold. The one or more processors identify second one or more pixels located at the first location in a second image of the multiple images. The second one or more pixels have a second brightness that does not meet the brightness threshold. Responsive to the detecting that the sensor aperture is occluded, an actuator of the sensor housing operates a cleaning mechanism to contact a screen of the sensor housing. The screen covers the sensor aperture.

In an embodiment, the cleaning mechanism includes an air knife emitted by an outlet slot of an air chamber located within the sensor housing of the vehicle.

In an embodiment, the first image is associated with a first size of the sensor aperture. The second image is associated with a second size of the sensor aperture smaller than the first size. A number of the first one or more pixels is smaller than a number of the second one or more pixels.

In an embodiment, the operating of the cleaning mechanism includes moving, by the actuator of the sensor housing, the cleaning mechanism to wipe debris, snow, or water from the screen.

In an embodiment, the operating of the cleaning mechanism includes moving, by an actuator of the sensor housing, the cleaning mechanism in at least one of a circular motion, a z-shaped motion, or a figure-of-8 motion.

In an embodiment, the operating of the cleaning mechanism includes controlling a motor of the sensor housing to move the cleaning mechanism.

In an embodiment, the motor of the sensor housing is air-cooled or liquid-cooled.

In an embodiment, the motor of the sensor housing is self-commutated or externally commutated.

In an embodiment, the motor of the sensor housing is at least one of a split-phase induction motor, a capacitor start induction motor, or a squirrel cage induction motor.

In an embodiment, the one or more processors detect that an audio sensor of the vehicle is occluded based on a hash of frequencies of peak points of audio signals captured by the audio sensor.

In an embodiment, the one or more processors detect that an audio sensor of the vehicle is occluded based on at least one of spectral flatness, prominent tones across a set of frequency bands, or bandwidth tracking.

In an embodiment, an actuator of the sensor housing is used to operate an air nozzle to clean an audio sensor of the vehicle responsive to detecting that the audio sensor is occluded and determining that the audio sensor is turned off.

In an embodiment, the sensor housing is made of at least one of engineering plastic, metal, or fiberglass.

In an embodiment, the detecting that the sensor aperture is occluded further includes transmitting, using the one or more processors, the first image and the second image to a machine learning model trained to determine whether the sensor aperture is occluded based on pixels in an image received using the sensor. The machine learning model is a mathematical and connectivity model constructed based on sample data, known as “training data,” to make predictions or decisions without being explicitly programmed to perform the task. The machine learning model is described in more detail with reference to FIG. 16. The machine learning model is used to determine that the sensor aperture is occluded based on the first one or more pixels and the second one or more pixels.

In an embodiment, a sensor housing of a vehicle includes a sensor casing. The sensor casing includes a sensor of the vehicle and a screen covering at least a portion of the sensor. An air chamber is mounted on the sensor casing and shaped to contain pressurized air. The air chamber includes an inlet shaped to allow the pressurized air to enter the air chamber. An outlet slot is shaped to emit the compressed air in a manner to prevent occlusion of the sensor.

In an embodiment, the occlusion of the sensor is prevented by the emitted compressed air wiping debris, snow, or water off the screen.

In an embodiment, the sensor casing is made of at least one of engineering plastic, metal, or fiberglass.

In an embodiment, the air chamber is made of at least one of engineering plastic, metal, or fiberglass.

In an embodiment, the outlet slot shapes the pressurized air emitted by the outlet slot into an air knife.

In an embodiment, the outlet slot is shaped to emit the pressurized air to wipe debris, water, or snow from a surface of the screen.

In an embodiment, the inlet is shaped to receive the pressurized air via a tubing having a first end and a second end. The first end of the tubing is operably coupled to the inlet. The second end of the tubing is operably coupled to an air pump driven by a motor. The air pump is configured to pump the pressurized air via the tubing towards the inlet.

In an embodiment, the pressurized air emitted by the outlet slot follows a laminar path parallel to a surface of the screen.

In an embodiment, the screen has a concave shape and the pressurized air emitted by the outlet slot bends inward to follow the concave shape of the screen.

In an embodiment, the sensor is a fisheye lens and the screen has a convex shape. The pressurized air emitted by the outlet slot bends outward to follow the convex shape of the screen.

In an embodiment, the outlet slot is shaped to emit the pressurized air in spaced relationship with a surface of the screen.

In an embodiment, a thickness of the outlet slot is in a range from 0.01 mm to 1 mm.

In an embodiment, the sensor housing is configured to emit the pressurized air at a pressure in a range from 1 MPa to 0.1 MPa.

In an embodiment, the sensor housing is configured to emit the pressurized air in bursts in a range from 0.01 seconds to 0.1 seconds.

In an embodiment, a volume of the pressurized air emitted by the outlet slot is in a range from 30 liters to 200 liters.

In an embodiment, the outlet slot is shaped to emit the pressurized air at an outlet angle in a range from 90° to 179°.

In an embodiment, the air chamber is sized to receive the pressurized air at a rate in a range from 0.5 CFM to 2 CFM.

In an embodiment, a width of the screen is in a range from 15 mm to 45 mm.

In an embodiment, a width of the air knife is in a range from 30 mm to 60 mm.

In an embodiment, the air chamber is sized such that pressurized air is emitted at a rate in a range from 1 liter/second to 3 liter/second.

In an embodiment, a LiDAR housing includes a LiDAR casing having a cylindrical shape. The LiDAR casing includes multiple LiDAR sensors disposed in a spaced configuration along a peripheral surface of the LiDAR casing. An air chamber is mounted on a base of the LiDAR casing. The air chamber is shaped to contain pressurized air. The air chamber includes multiple outlet slots disposed along a periphery of the air chamber. Each outlet slot of the multiple outlet slots is shaped to emit a respective portion of the pressurized air in a manner to prevent occlusion of one or more LiDAR sensors of the multiple LiDAR sensors.

In an embodiment, the LiDAR housing is configured to turn off one or more outlet slots of the multiple outlet slots to prevent one or more corresponding portions of the pressurized air from being emitted.

In an embodiment, each outlet slot of the multiple outlet slots is shaped to emit the respective portion of the pressurized air in a direction across the peripheral surface of the LiDAR casing.

In an embodiment, the air chamber further includes multiple inlets shaped to allow the pressurized air to enter the air chamber.

In an embodiment, each outlet slot of the multiple outlet slots is spaced apart from a successive outlet slot of the multiple outlet slots.

In an embodiment, the LiDAR housing is made of at least one of engineering plastic, metal, or fiberglass.

In an embodiment, the LiDAR casing is made of at least one of engineering plastic, metal, or fiberglass.

In an embodiment, the air chamber is made of at least one of engineering plastic, metal, or fiberglass.

In an embodiment, each outlet slot of the multiple outlet slots emits the respective portion of the pressurized air in a direction from the base of the LiDAR casing to a top of the LiDAR casing.

In an embodiment, each outlet slot of the multiple outlet slots is shaped to emit the respective portion of the pressurized air to remove a material occluding the one or more LiDAR sensors of the multiple LiDAR sensors.

In an embodiment, the multiple air slots are angled to emit multiple intersecting portions of the pressurized air.

In an embodiment, the multiple outlet slots are shaped to emit the pressured air in a reticulated pattern.

In an embodiment, the air chamber has a flange shape.

In an embodiment, the air chamber forms a conduit for the pressurized air to flow from the multiple inlets to the multiple outlet slots.

In an embodiment, each outlet slot of the multiple outlet slots is shaped to emit the respective portion of the pressurized air oblique to a plane defined by a surface of the air chamber.

In an embodiment, the respective portion of the pressurized air exits the LiDAR housing diverging tangentially from the peripheral surface of the LiDAR casing.

In an embodiment, each inlet of the multiple inlets is shaped to receive the pressurized air via a respective tubing having a first end and a second end. The first end of the tubing is operably coupled to the inlet. The second end of the tubing is operably coupled to an air pump driven by a motor. The air pump is configured to pump the pressurized air via the tubing towards the inlet.

In an embodiment, a thickness of each outlet slot is in a range from 0.01 mm to 1 mm.

In an embodiment, the LiDAR housing is configured to emit the pressurized air in bursts in a range from 0.01 seconds to 0.1 seconds.

In an embodiment, the multiple inlets are sized to receive the pressurized air at a rate in a range from 0.1 MPa to 1 MPa.

In an embodiment, a length of each outlet slot is in a range from 20 mm to 60 mm.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A system comprising:
a sensor housing, the sensor housing including:
a first sensor comprising a sensor aperture;
a motor rotatable about a first fixed axis of revolution, wherein the motor is configured to be actuated when the first sensor's accuracy is below a threshold accuracy value;
a substantially transparent screen rotatable about a second fixed axis of revolution, the substantially transparent screen being mechanically coupled to the motor and covering at least a portion of the sensor aperture when the motor is in a first operational condition; and
a cleaning mechanism located proximate to the screen when the motor is in at least a second operational condition, the cleaning mechanism configured to contact the substantially transparent screen.

2. The system of claim 1, wherein at least a portion of the cleaning mechanism comprises a microfiber material.

3. The system of claim 1, wherein the cleaning mechanism comprises an outlet configured to release pressurized air.

4. The system of claim 1, wherein at least a portion of the cleaning mechanism comprises a cellulose sponge.

5. The system of claim 1, wherein the motor is further configured to be actuated when the first sensor detects an occlusion.

6. The system of claim 1, wherein the motor is mechanically coupled to the screen using a line and one or more pulleys.

7. The system of claim 1 further comprising a second sensor configured to perform sensing operations when the motor is actuated.

8. The system of claim 1, wherein the first axis of revolution and the second axis of revolution are oriented in substantially similar directions.

9. The system of claim 1, wherein at least a portion of the screen comprises an acrylic-based material.

10. The system of claim 1, wherein at least a portion of the screen comprises polyethylene terephthalate or thermoplastic polyurethane.

11. The system of claim 1, wherein the motor is configured to output a torque having a value of at least 1 newton-meter.

12. The system of claim 1, wherein the motor is configured to rotate at a rotational speed of at least one rotations per minute.

13. A method, comprising:
rotating, by a motor rotatable about a first axis of revolution, a substantially transparent screen covering at least a portion of an aperture of a first sensor when the motor is in a first position, wherein the screen is rotated about a second fixed axis of revolution; and
contacting, by a cleaning mechanism located proximate to the screen when the motor is in at least a second position, the screen to remove one or more substances from the screen.

14. The method of claim 13, further comprising actuating the motor when an accuracy of the sensor accuracy is below a threshold accuracy value.

15. The method of claim 13, further comprising performing, by a second sensor, sensing operations during the rotating of the screen.

16. The method of claim 13, wherein rotating the screen comprises rotating the motor at a rotational speed of at least one rotations-per-minute.

17. The method of claim 13, wherein at least a portion of the cleaning mechanism comprises a microfiber material and contacting the screen comprises contacting the screen with the microfiber material.

18. The method of claim 13, wherein the cleaning mechanism comprises an outlet configured to release pressurized air and contacting the screen comprises contacting the screen with the pressurized air.

19. The method of claim 13, wherein rotating the screen comprises using a line and one or more pulleys to rotate the screen.

20. The method of claim 13, further comprising actuating the motor when the first sensor detects an occlusion.
